(19) United States
(12) Patent Application Publication
(10) Pub. No.: US 2018/0091405 A1
(43) Pub. Date: Mar. 29, 2018

(54) SOFTWARE METHOD TO DETECT AND PREVENT SILENT DATAPATH IP ROUTE LOOKUP FAILURES

(71) Applicant: ALCATEL-LUCENT CANADA INC., Ottawa (CA)

(72) Inventors: Toby J. KOKTAN, Dunrobin (CA); Andre POULIN, Gatineau (CA)

(73) Assignee: ALCATEL-LUCENT CANADA, INC.

(21) Appl. No.: 15/280,591

(22) Filed: Sep. 29, 2016

(51) Int. Cl. H04L 12/26; H04L 12/741; H04L 29/08

(52) U.S. Cl. CPC H04L 43/0847; H04L 67/1097; H04L 45/745

(57) ABSTRACT

Various embodiments relate to an apparatus, method and a non-transitory computer readable medium including a control plane microprocessor which is configured receive a first route from a forwarding information base, generate an internet protocol (IP) address lookup based on the first route and generate an IP route lookup request based on the IP address lookup, a shared memory configured to receive the IP route lookup request from the control plane microprocessor and a datapath processor configured to receive an IP lookup request from the control plane microprocessor, receive the IP route lookup request from the shared memory and perform an IP route datapath lookup on a storage device, wherein the control plane microprocessor compares the result of the IP route datapath lookup to the first route.

### TECHNICAL FIELD

The disclosure relates generally to monitoring IP route lookups, and more specifically, but not exclusively, to simulating packet classification lookups to detect and prevent datapath IP route lookup silent failures.

### BACKGROUND

Network processors (NPs) are employed in many of today's communications products, as opposed to traditional application specific integrated circuits (ASICs) or field programmable gate array (FPGA) fixed hardware, primarily because the architecture of these processors provides the flexibility of a software based feature set solution with the high performance of ASICs. Network processors utilize parallel processing or serial pipelines and are programmable, but are optimized for packet processing operations required by data packet network communication devices.

Routers use control plane protocols to build IPv4/IPv6 VRFx forwarding information bases which are programmed into a hardware storage device and used by a datapath processor to perform fastpath route lookups on incoming packets. A packet forwarding decision is based on the lookup result.

Common hardware employed for this purpose include Ternary Content Addressable Memory (TCAM) or traditional high-speed Random Access Memory (RAM) which stores a trie data structure used for a Longest Prefix Match (LPM) lookup along with the hardware devices necessary to interface the datapath lookup processor to these memory devices, using for example buses and FPGAs. For IPv4/v6 routing lookups, the entries are sorted based on the address prefix lengths in the forwarding table in order to guarantee longest prefix matching.

Ternary Content Addressable Memory hardware devices are commonly used in today's high performance routers for fast routing lookups and packet classification. A TCAM search will compare selected fields from the header of the incoming packet against all entries in the forwarding table in parallel. A datapath lookup processor will access the TCAM either directly over dedicated bus (e.g. SerDes) or via interface hardware which may include buses and an FPGA. The tradeoff of this high performance lookup is the hardware complexity and corresponding difficulty to detect failures anywhere in this hardware path. A lookup result may be incorrect for many possible reasons due to a transient or persistent software or hardware fault.

For example, trie type data structures stored in high-speed memory device which are used for IP route datapath lookups could be corrupted by a software or hardware error.

### SUMMARY OF EXEMPLARY EMBODIMENTS

A brief summary of various embodiments is presented below. Embodiments address the need to mitigate the potential for silent traffic loss in a datapath lookup processor such as a network processor, ASIC or FPGA.

In order to overcome these and other shortcomings of the prior art and in light of the present need for a method for a software method to detect and prevent silent datapath IP route lookup failures, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a router comprising a control plane microprocessor configured to receive a first route from a forwarding information base, generate an internet protocol (IP) address lookup based on the first route and generate an IP route lookup request based on the IP address lookup, a shared memory configured to receive the IP route lookup request from the control plane microprocessor and a datapath processor configured to receive an IP lookup request from the control plane microprocessor, receive the IP route lookup request from the shared memory and perform an IP route datapath lookup on a storage device, wherein the control plane microprocessor compares the result of the IP route datapath lookup to the first route.

In an embodiment of the present disclosure, the IP route lookup request is stored in the shared memory.

In an embodiment of the present disclosure, the result of the IP route datapath lookup is transmitted from the datapath processor to the shared memory.

In an embodiment of the present disclosure, the control plane microprocessor is configured to determine whether the result of the IP route datapath lookup matches the first route, then receiving a subsequent route.

In an embodiment of the present disclosure, the control plane microprocessor is configured to determine whether the result of the IP route datapath lookup does not match the first route, then the datapath processor being configured to receive the IP lookup request from the control plane microprocessor, receive the IP route lookup request from the shared memory and perform an IP route datapath lookup on the storage device.

In an embodiment of the present disclosure, the storage device is a ternary content-addressable memory or a trie search data structure in a high-speed memory device.

In an embodiment of the present disclosure, the control plane microprocessor is configured to receive the subsequent route until all routes have been checked.

Various embodiments described herein relate to a method for detecting and verifying datapath lookup results, the method comprising receiving, by a control plane microprocessor, a first route, generating an internet protocol (IP) address lookup based on the first route and generating an IP route lookup request based on the IP address lookup, receiving, by a datapath processor, the IP route lookup request, from the control plane microprocessor, receiving, by the datapath processor, an IP lookup request, from the control plane microprocessor receiving, by the datapath processor, the IP route lookup request from the shared memory, and performing, by the datapath processor, an IP route datapath lookup, on a storage device, wherein the control plane microprocessor compares the result of the IP route datapath lookup to the first route.

In an embodiment of the present disclosure, the IP route lookup request is stored in the shared memory.

In an embodiment of the present disclosure, the result of the IP route datapath lookup is transmitted from the datapath processor to the shared memory.

In an embodiment of the present disclosure, the control plane microprocessor is configured to determine whether the result of the IP route datapath lookup matches the first route, then receiving a subsequent route.

In an embodiment of the present disclosure, the control plane microprocessor is configured to determine whether the result of the IP route datapath lookup does not match the first route, then the datapath processor being configured to receive the IP lookup request from the control plane microprocessor, receive the IP route lookup request from the shared memory and perform an IP route datapath lookup on the storage device.

In an embodiment of the present disclosure, the storage device is a ternary content-addressable memory or a trie search data structure in a high-speed memory device.

In an embodiment of the present disclosure, the control plane microprocessor is configured to receive the subsequent route until all routes have been checked.

Various embodiments described herein relate to a non-transitory computer readable medium storing program code for detecting and verifying datapath lookup results, the program code being executable by a process to perform operations comprising receiving, by a control plane microprocessor, a first route, generating an internet protocol (IP) address lookup based on the first route and generating an IP route lookup request based on the IP address lookup, receiving, by a datapath processor, the IP route lookup request, from the control plane microprocessor, receiving, by the datapath processor, an IP lookup request, from the control plane microprocessor receiving, by the datapath processor, the IP route lookup request from the shared memory and performing, by the datapath processor, an IP route datapath lookup on a storage device, wherein the control plane microprocessor compares the result of the IP route datapath lookup to the first route.

In an embodiment of the present disclosure, the IP route lookup request is stored in the shared memory.

In an embodiment of the present disclosure, the result of the IP route datapath lookup is transmitted from the datapath processor to the shared memory.

In an embodiment of the present disclosure, the control plane microprocessor is configured to determine whether the result of the IP route datapath lookup matches the first route, then receiving a subsequent route.

In an embodiment of the present disclosure, the control plane microprocessor is configured to determine whether the result of the IP route datapath lookup does not match the first route, then the datapath processor being configured to receive the IP lookup request from the control plane microprocessor, receive the IP route lookup request from the shared memory and perform an IP route datapath lookup on the storage device.

In an embodiment of the present disclosure, the storage device is a ternary content-addressable memory or a trie search data structure in a high-speed memory device.

In an embodiment of the present disclosure, the control plane microprocessor is configured to receive the subsequent route until all routes have been checked.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features of the present invention are more fully disclosed in the following specification, reference being had to the accompanying drawings, in which:

FIG. 1 is a block diagram of a router.

FIG. 2 is a flow chart of a method to perform and verify datapath lookup results against the entire control plane FIB (forwarding information base).

FIG. 3 is a block diagram of a processor and memory.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated. Descriptors such as “first,” “second,” “third,” etc., are not meant to limit the order of elements discussed, are used to distinguish one element from the next, and are generally interchangeable.

When any of the software and/or hardware components involved with the IP route programming by the control plane or the datapath lookup fail, it can be very difficult to detect and often the end result is a silent routing lookup failure which results in misrouted or dropped customer traffic. Further, when datapath route lookups do not return the correct result (as determined by the control plane), then customer traffic will be adversely affected and the failure will often be silent.

By way of a first example, if a router spontaneously began dropping IP routed traffic in a customer deployment and an investigation confirmed that the routing information should have been properly programmed into the datapath but error statistics were incrementing due to IP route lookup failures, the cause would likely be that the route lookup trie data structure had become corrupt. Simulating packet classification lookups to detect datapath IP route lookup failure(s) would have prevented the silent failure due to this corruption.

By way of a second example, a datapath processor operating in a harsh (e.g. humidity and airborne contaminants) environment developed corrosion that adversely affected the signal integrity on the bus between the datapath processor and the TCAM. In this case, all IP route database entry programming operations would complete successfully on the control plane bus; however when IP route lookups (i.e. TCAM searches) were issued over the datapath bus with the signal integrity issue, the lookup key would be corrupted and would result in an erroneous and undetectable match in the TCAM device.

By way of a third example, a TCAM was employed whereby some internal database array elements were not initialized during device configuration and boot up. This caused search failures (no match or a mismatch) during runtime despite valid and error-free database entry programming operations.

There are several approaches to data corruption in the related art. For example, parity and error-correcting code memory (ECC) are options in the datapath lookup storage device to effectively detect single-bit corruption due to software or hardware fault. However, when there is multi-bit corruption or errors occurring in the route lookup data presented along hardware path or in a lookup result between the datapath processor and the storage device due to some hardware fault, parity and ECC will likely fail to detect and result in a lookup failure.

As mentioned above, soft-errors (single bit flips) can be mitigated effectively with hardware based error correction coding protection. However in many cases it is not practical or even feasible to have ECC coverage across all memories and buses of a given datapath processor. Furthermore, ECC does not protect against multi-bit corruption or microcode software defects that can also lead to memory corruption.

Hardware based ECC is not always feasible for various reasons, such as one or a combination of the following: added expense, insufficient space on the datapath processor to accommodate the extra hardware logic required for ECC codes, and performance degradation associated with the ECC hardware.

Good hardware design and component quality can reduce but cannot completely eliminate the possibility of memory corruption due to soft-errors. Similarly, good software development practices can reduce but cannot completely eliminate the possibility of software bugs that escape development testing.

Therefore, aside from an in-service live traffic flow test there is no known way to validate all datapath IP route lookup results and compare them to expected results in the control plane forwarding information base (FIB) and detect lookup failures due to a software and/or hardware fault or corruption of a trie data structure used for longest prefix matching.

Therefore, it is desirable to have a universal means to validate and verify IP routing datapath lookups for the entire FIB with a software method that is configured to be hardware platform-agnostic.

To solve this problem, a software method is disclosed to perform and fully verify datapath lookup results against the entire IPv4/IPv6 VRFx control plane FIB. This method provides a way to simulate packet classification lookups in the datapath without any real live traffic flow and detect lookup failures for any possible route(s). This software method is executed continuously in real-time, as a background diagnostic. This software method utilizes all the same software and hardware components involved with live traffic IP route lookup datapath processing and therefore is able to detect any fault that might cause lookup failures thereby preventing silent routing failures.

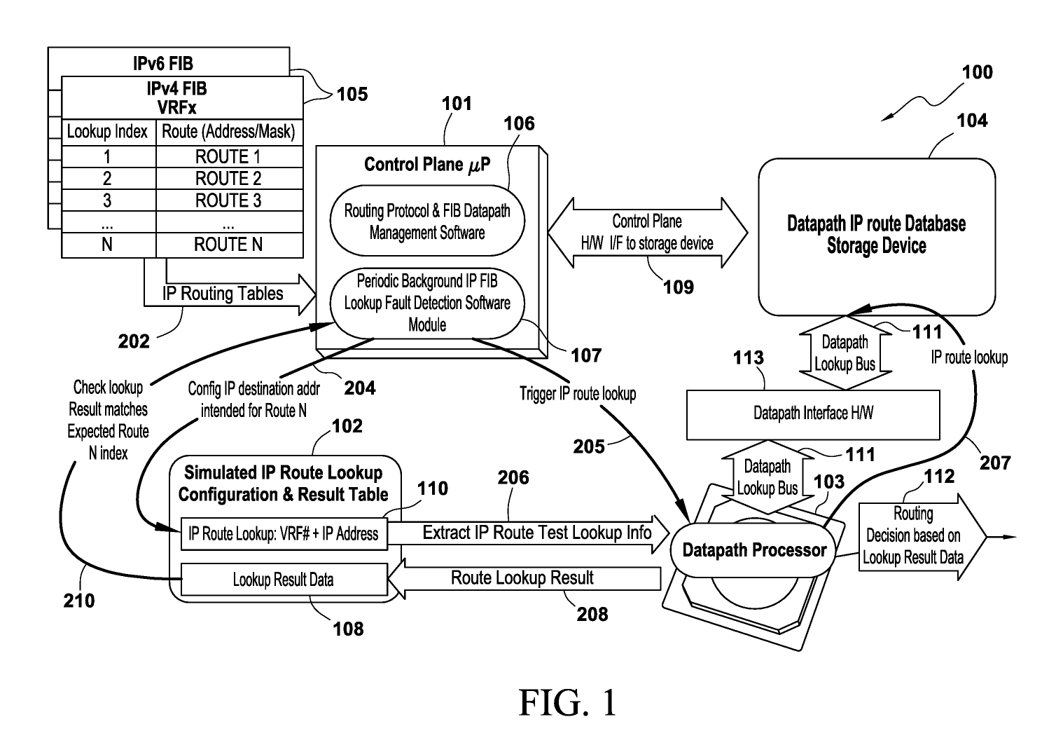

FIG. 1 illustrates a router 100 including a control plane microprocessor 101, a shared memory 102, a datapath processor 103, a storage device 104 and an IPv4/IPv6 VRFx control plane forwarding information base 105.

The control plane microprocessor 101 includes a Routing Protocol and FIB Datapath Management Software module 106 and a Periodic Background IP FIB Lookup Fault Detection Software Module 107.

The Periodic Background IP FIB Lookup Fault Detection Software Module 107 executes on the control plane microprocessor 101. This software module 107 is responsible for processing through the entire forwarding information base 105 and configuring an IP address lookup designed to match specifically on every route entry. This software module 107 will then trigger a lookup by the datapath processor 103 and wait for the result and compare it against the expected route lookup result; whereby failures detected will be alerted on the router 100.

The forwarding information base 105 includes one or multiple IP routing table instances configured with lookup indexes and routes (address/mask) for each respective index. For IPv4/v6 routing lookups the entries are sorted based on the address prefix lengths in the forwarding table in order to guarantee longest prefix matching (LPM).

The shared memory 102 stores a Simulated IP Route Lookup Configuration and Result Table including an IP Route Lookup 110 and Lookup Result Data 108.

The Simulated IP Route Lookup Configuration and Result Table is created in the shared memory 102 accessible by both the control plane microprocessor 101 and the datapath processor 103. This table stores each test lookup consisting of an IP address and VRF (virtual routing and forwarding) instance configured by the control plane microprocessor 101 to be accessed by the datapath processor 103. The results of the lookup with this data will also be stored back to this table for evaluation by the control plane microprocessor 101.

The datapath processor 103, for example, can be a datapath processor or an application specific integrated circuit (ASIC).

Datapath processor 103 performs a test lookup which is triggered by the control plane microprocessor 103. The datapath microprocessor 103 will launch a lookup using data retrieved from the shared memory 102 using the identical path as a live IP packet lookup and store the result back to the table on the shared memory 102.

The storage device 104 is a Datapath IP Route Database Storage Device. The storage device 104, for example, can be a TCAM (records/masks) or a SDRAM/SDRAM (Trie search data structure).

In some embodiments, the datapath processor 103 performs an LPM lookup to an external SDRAM device storing a trie data structure.

In an alternative embodiment, the datapath processor 103 interfaces with a TCAM device either over zero bus turnaround (ZBT) to an FPGA or directly via SerDes link.

The router 100 includes a control plane interface 109 between the control plane 101 and the datapath IP route database storage device

The router 100 has a series of datapath lookup buses 111 and a datapath interface hardware 113.

The router 100 includes datapath lookup buses 111 positioned between the datapath IP route database storage device 104 and the datapath interface hardware 113 and positioned between the datapath processor 103 and the datapath interface hardware 113.

Furthermore, the datapath processor 103 in the router 100 forwards packets based on the lookup result 112.

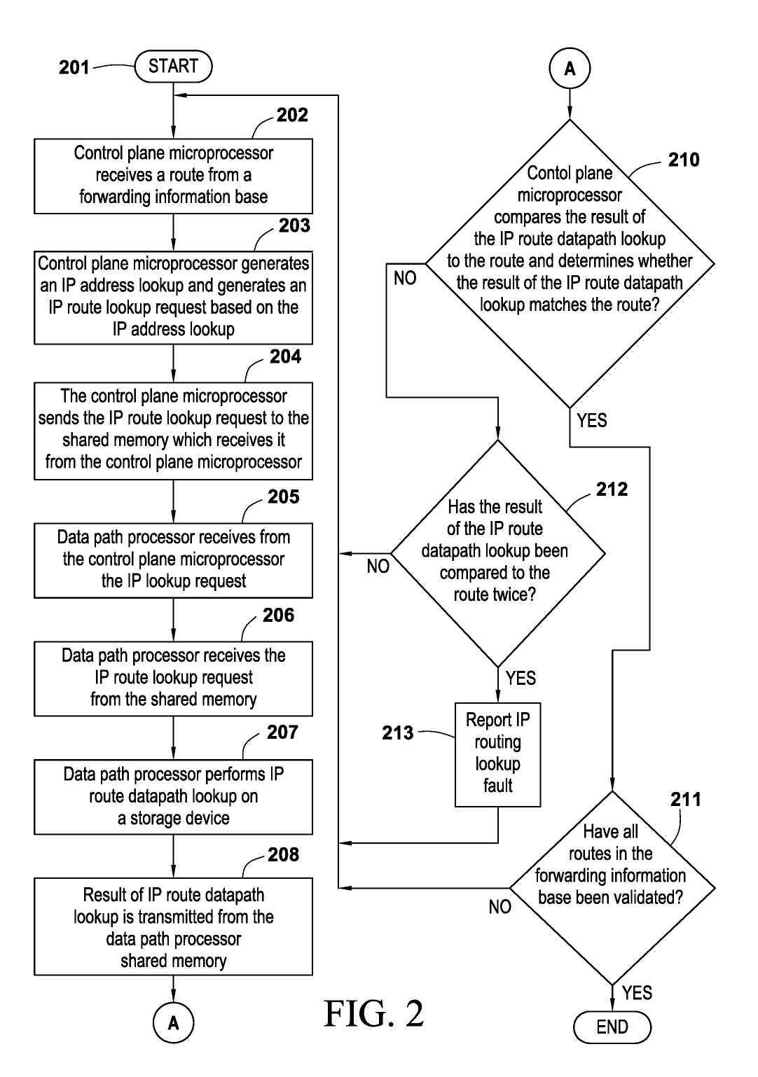

FIG. 1 includes reference numerals 202, 204, 206, 207 208, and 209 which refer to method steps in FIG. 2 to the corresponding path of information flow in FIG. 1 and which are described in greater detail below.

FIG. 2 is a flow chart illustrating an embodiment of a method 200 for simulating packet classification lookups to detect and prevent datapath IP route lookup silent failures (utilizing the router 100 in FIG. 1).

The method 200 begins in step 201. Execution of the method 200 continues to Step 202 where the control plane microprocessor 101 loads a route from the IP forwarding base 105 with an index N. Each route from the IP forwarding base 105 with an index N is verified in order.

The method 200 continues to step 203 where the control plane microprocessor 101 generates an IP address lookup which will hit that route (from the IP forwarding base 105 with index N) and generates an IP route lookup request based on the IP address lookup.

The method 200 continues to step 204 where the control plane microprocessor 101 sends the IP route lookup request to the shared memory 102 which receives it from the control plane microprocessor 101. The IP address lookup is stored in the Simulated IP Route Lookup Configuration and Result Table 102.

The method 200 continues to step 205 where the datapath processor 103 receives the IP lookup request from the control plane microprocessor 101.

The method 200 continues to step 206 where the datapath processor 103 retrieves the IP route lookup request from the shared memory 102.

The method 200 continues to step 207 where the datapath processor 103 performs IP route datapath lookup on a storage device 104. The datapath processor 103 is configured to launch a thread to perform the lookup and loads the IP address from the lookup configuration table. The datapath processor 103 does an IP route datapath lookup over the hardware interface 109 to the storage device 104. The result of the IP route datapath lookup is a route.

The method 200 continues to step 208 where the result of the IP route datapath lookup is transmitted from the datapath processor 103 to the shared memory 102.

The method 200 continues to step 210 where the control plane microprocessor 101 compares the result of the IP route datapath lookup to the route and determines whether the result of the IP route datapath matches the route. If yes, the method 200 proceeds to step 211 which determines whether all the routes in the forwarding information base 105 have been verified and validated. The method 200 is executed periodically in the background, unless a failure is encountered. If a mismatch is detected, the method 200 proceeds to step 212 to determine whether the result of the IP route datapath lookup has been twice compared to the route.

If at step 211, all the routes in the forwarding information base 105 have been verified and validated, then the method 200 proceeds to end 214. Alternatively, the method can continue by starting the process of checking each entry in the forwarding information base 105 at the first entry of the forwarding information base 105.

If at step 211, all the routes in the forwarding information base 105 have not been verified and validated, then the method 200 proceeds to the step 202 of the method 200.

If at step 212, the result of the IP route datapath lookup has been twice compared and mismatched to the expected route, then the method 200 proceeds to step 213 which reports an IP route lookup fault. The method 200 proceeds from step 213 the step 202 to continue the process.

If at step 212, the result of the IP route datapath lookup has not been twice compared to the route, then the method 200 proceeds back to step 202 where the control plane microprocessor 101 receives a route from a forwarding information base 105.

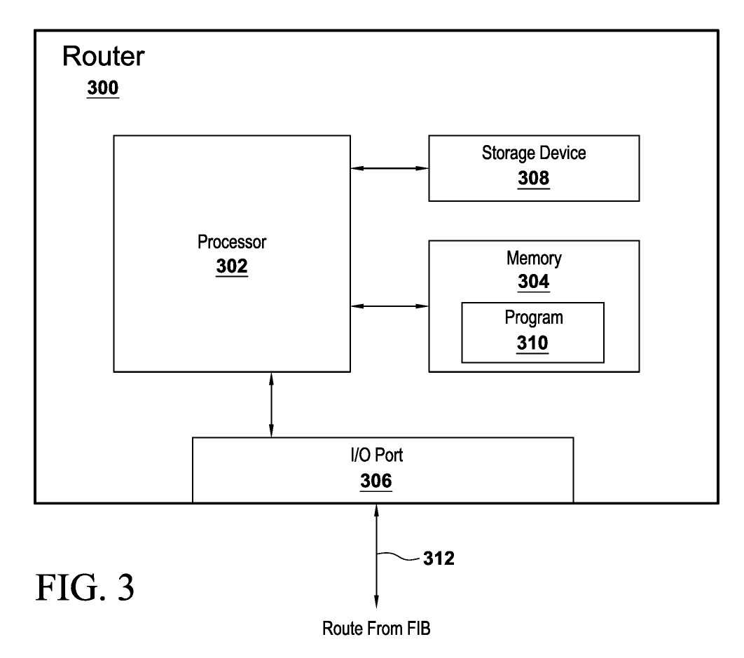

FIG. 3 depicts an apparatus 300 for performing steps of the method depicted in FIG. 2. For example, the apparatus 300 could be the router 100, the control plane microprocessor 101, or the datapath processor 103. The apparatus includes a processor 302, a memory 304 that is in communication with the processor 302, a input/output (I/O) port 306 that is in communication with the processor 302, and a storage device 308 (e.g. a TCAM or SDRAM or SDRAM) that is also in communication with the processor 302. The memory includes a program 310 that has instructions on the storage device 308, which when executed by the processor cause steps of the method 200 to be performed. The processor 302 in conjunction with the storage device 308 enables the apparatus 300 to effect detection and prevention of datapath IP route lookup silent failures and communicate those failures over the I/O port 306.

The processor 302 may be any hardware device capable of executing instructions stored in memory 304 or storage device 308 or otherwise processing data. As such, the processor 302 may include a non-general purpose microprocessor, field programmable gate array (FPGA), application-specific integrated circuit (ASIC), or other similar devices.

The memory 304 may include various memories such as, for example L1, L2, or L3 cache or system memory. As such, the memory 304 may include static random access memory (SRAM), dynamic RAM (DRAM), flash memory, read only memory (ROM), or other similar memory devices.

The network interface 312 may include one or more devices for enabling communication with other hardware devices. For example, the network interface 312 may include a network interface card (NIC) configured to communicate according to the Ethernet protocol. Additionally, the network interface 312 may implement a TCP/IP stack for communication according to the TCP/IP protocols. Various alternative or additional hardware or configurations for the network interface 312 will be apparent.

The storage device 308 may include one or more machine-readable storage media such as read-only memory (ROM), random-access memory (RAM), magnetic disk storage media, optical storage media, flash-memory devices, or similar storage media. In various embodiments, the storage device 308 may store instructions for execution by the processor 302 or data upon with the processor 302 may operate. For example, the storage 308 may store a base operating system for controlling various basic operations of the hardware 300.

It will be apparent that various information described as stored in the storage device 308 may be additionally or alternatively stored in the memory 304. In this respect, the memory 304 may also be considered to constitute a “storage device” and the storage device 308 may be considered a “memory.” Various other arrangements will be apparent. Further, the memory 304 and storage device 308 may both be considered to be “non-transitory machine-readable media.” As used herein, the term “non-transitory” will be understood to exclude transitory signals but to include all forms of storage, including both volatile and non-volatile memories.

While the host device 300 is shown as including one of each described component, the various components may be duplicated in various embodiments. For example, the processor 302 may include multiple microprocessors that are configured to independently execute the methods described herein or are configured to perform steps or subroutines of the methods described herein such that the multiple processors cooperate to achieve the functionality described herein. Further, where the device 300 is implemented in a cloud computing system, the various hardware components may belong to separate physical systems. For example, the processor 302 may include a first processor in a first server and a second processor in a second server.

Advantageously, this software mechanism will effectively eliminate very undesirable customer service outages or “silent failures” that may occur due to routing lookup fault from multiple possible causes with minimal network downtime. ECC is typically not implemented across all memories in use by the Network processor nor can it detect all forms of corruption that may occur in a the hardware path for a datapath lookup This software solution can be applied to existing products which are already deployed in customer networks (i.e. no new hardware needed). The solution provides an effective mitigation against worst-case network equipment failure scenarios and helps reduce potential product returns (and damage to customer perceived quality) following a network outage or silent failure. Overall, embodiments of the invention improve the robustness of telecom products by increasing the reliability of network processors based architectures.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A router comprising:
a control plane microprocessor configured to receive a first route from a forwarding information base, generate an internet protocol (IP) address lookup based on the first route, and generate an IP route lookup request based on the IP address lookup;
a shared memory configured to receive the IP route lookup request from the control plane microprocessor; and
a datapath processor configured to receive an IP lookup request from the control plane microprocessor, receive the IP route lookup request from the shared memory and perform an IP route datapath lookup on a storage device,
wherein the control plane microprocessor compares the result of the IP route datapath lookup to the first route.

2. The router of claim 1, wherein the IP route lookup request is stored in the shared memory.

3. The router of claim 1, wherein the result of the IP route datapath lookup is transmitted from the datapath processor to the shared memory.

4. The router of claim 1, wherein the control plane microprocessor is configured to determine the result of the IP route datapath lookup matches the first route, then receiving a subsequent route.

5. The router of claim 1, wherein the control plane microprocessor being configured to determine whether the result of the IP route datapath lookup does not match the first route, then the datapath processor being configured to receive the IP request from the control plane microprocessor, receive the IP route lookup request from the shared memory, and perform an IP route datapath lookup on the storage device.

6. The router of claim 1, wherein the storage device is a ternary content-addressable memory or a trie search data structure residing in a high-speed memory device.

7. The router of claim 4, wherein the control plane microprocessor is configured to receive the subsequent route until all routes have been checked.

8. A method for detecting and verifying datapath lookup results, the method comprising:
receiving, by a control plane microprocessor, a first route, generating an internet protocol (IP) address lookup based on the first route and generating an IP route lookup request based on the IP address lookup;
receiving, by a datapath processor, the IP route lookup request, from the control plane microprocessor,
receiving, by the datapath processor, an IP lookup request, from the control plane microprocessor receiving, by the datapath processor, the IP route lookup request from the shared memory, and performing, by the datapath processor, an IP route datapath lookup on a storage device,
wherein the control plane microprocessor compares the result of the IP route datapath lookup to the first route.

9. The method of claim 8, wherein the IP route lookup request is stored in the shared memory.

10. The method of claim 8, wherein the result of the IP route datapath lookup is transmitted from the datapath processor to the shared memory.

11. The method of claim 8, further comprising, determining by the control plane microprocessor that the result of the IP route datapath lookup matches the first route, then receiving a subsequent route.

12. The method of claim 8, further comprising determining by the control plane microprocessor whether the result of the IP route datapath lookup does not match the first route, then receiving by the datapath processor the IP lookup request from the control plane microprocessor, receiving the IP route lookup request from the shared memory, and performing an IP route datapath lookup on the storage device.

13. The method of claim 8, wherein the storage device is a ternary content-addressable memory or a trie search data structure residing in a high-speed memory device.

14. The method of claim 11, wherein the control plane microprocessor is configured to receive the subsequent route until all routes have been checked.

15. A non-transitory computer readable medium storing program code for detecting and verifying datapath lookup results, the program code being executable by a process to perform operations comprising:
receiving, by a control plane microprocessor, a first route, generating an internet protocol (IP) address lookup based on the first route and generating an IP route lookup request based on the IP address lookup;
receiving, by a datapath processor, the IP route lookup request, from the control plane microprocessor,
receiving, by the datapath processor, an IP lookup request, from the control plane microprocessor receiving, by the datapath processor, the IP route lookup request from the shared memory, and performing, by the datapath processor, an IP route datapath lookup on a storage device,
wherein the control plane microprocessor compares the result of the IP route datapath lookup to the first route.

16. The non-transitory computer readable medium of claim 15, wherein the IP route lookup request is stored in the shared memory.

17. The non-transitory computer readable medium of claim 15, wherein the result of the IP route datapath lookup is transmitted from the datapath processor to the shared memory.

18. The non-transitory computer readable medium of claim 15, further comprising, determining by the control plane microprocessor that the result of the IP route datapath lookup matches the first route, then receiving a subsequent route.

19. The non-transitory computer readable medium of claim 15, further comprising determining by the control plane microprocessor whether the result of the IP route datapath lookup does not match the first route, then receiving by the datapath processor the IP lookup request from the control plane microprocessor, receiving the IP route lookup request from the shared memory, and performing an IP route datapath lookup on the storage device.

20. The non-transitory computer readable medium of claim 15, wherein the storage device is a ternary content-addressable memory or a trie search data structure residing in a high-speed memory device.

21. The non-transitory computer readable medium of claim 18, wherein the control plane microprocessor is configured to receive the subsequent route until all routes have been checked.
